(19) United States
(12) Patent Application Publication
(10) Pub. No.: US 2010/0131087 A1
(43) Pub. Date: May 27, 2010

(54) RECORDER WITH INSTANT PLAYBACK FUNCTION AND METHOD OF USING

(76) Inventor: JUSTIN LIBIGS, Waterford, WI (US)

Correspondence Address: James Ray & Associates, 2640 Pitcairn Road, Monroeville, PA, 15146, US

(21) Appl. No.: 12/606,394

(22) Filed: Oct. 27, 2009

Related U.S. Application Data
(60) Provisional application No. 61/117,973, filed on Nov. 26, 2008.

(51) Int. Cl. G06F 17/00

(52) U.S. Cl. 700/94

(57) ABSTRACT

The present invention in several embodiments is a recorder with software enabled instant playback function designed to be used by paranormal investigators to improve the recording and response to electronic voice phenomenon (EVP). EVP is voice that cannot be heard until the audio recording is played back. This product could be a modification to existing digital voice recorders, which incorporates a headset that would allow the listener to hear the audio a few seconds after recording without stopping the recording. This enables investigators to be able to immediately respond to the audio, creating better results and more direct communication with an entity.

### CROSS REFERENCE TO RELATED APPLICATION

This patent application is related to and claims priority from U.S. Provisional Patent Application Ser. No. 61/117,973 filed Nov. 26, 2008.

### FIELD OF THE INVENTION

The invention is related to audio recorders and players. The present invention is particularly applicable to audio recorders and players for paranormal research.

### BACKGROUND OF THE INVENTION

Currently, paranormal researchers use digital voice recorders to ask questions in hopes of receiving responses from an entity. These recordings cannot be checked until after the researcher is done and the audio is played back. This can be minutes later. When no EVPs are recorded, it is a waste of time to replay several minutes worth of audio. Without knowing if they are getting a response, investigators are unable to ask the questions they need answered. Presently, three investigators with separate recorders are needed. Each one records for two minutes, and then while they listen to the playback, the next investigator begins recording. Recording time is lost, and it takes too long to respond to the entity.

Accordingly, it has been considered desirable to develop a new and improved audio recorder which would overcome the foregoing difficulties and others while providing better and more advantageous overall results.

### SUMMARY OF THE INVENTION

The present invention in several embodiments is a recorder with software enabled instant playback function designed to be used by paranormal investigators to improve the recording and response to electronic voice phenomenon (EVP). EVP is voice that cannot be heard until the audio recording is played back. This product could be a modification to existing digital voice recorders, which incorporates a headset that would allow the listener to hear the audio a few seconds after recording without stopping the recording. This enables investigators to be able to immediately respond to the audio, creating better results and more direct communication with an entity.

The present invention allows researchers to respond instantly to an EVP, using less people and equipment. The invention itself is software enablement for a mobile audio recording system. When used in conjunction with a digital voice recorder, the device is designed to record any audio picked up in an area and play it back a couple seconds later. The components include software that preferably ensures a time delay of five to ten seconds. The software would be similar to that used with digital video recorders. The person using this system would set the time delay of their choice, put on a headset that is plugged into the digital voice recorder and press record.

### OBJECTS OF THE INVENTION

It is therefore one of the primary objects of the present invention to provide a digital voice recorder that can replay recorded audio while continuously recording audio.

Another object of the present invention is to provide a digital voice recorder that can replay recorded audio while simultaneously recording audio.

In one embodiment the invention is a portable audio recorder for digitally recording environmental sound comprising: a microphone, a means for capturing and storing a digitized representation of an environmental sound as a computer file on a computer readable and rewritable medium, a means for playing said digitized representation of an environmental sound from said computer file on said computer readable and rewritable medium, a speaker, wherein said digitized representation of an environmental sound is automatically played at a user selected time interval of at least one second. In another embodiment the user selected time interval is at least five seconds. In yet another embodiment the portable audio recorder records a sound associated with a paranormal phenomenon. In still another embodiment said speaker is at least one speaker positioned in a headset. In yet another embodiment said microphone is built into an external body of the portable audio recorder. In yet another embodiment said speaker is built into an external body of the portable audio recorder. In still another embodiment said microphone is built into an external body of the portable audio recorder, and wherein said speaker is built into the external body of the portable audio recorder.

In still another embodiment the invention is a method for obtaining an audio recording associated with a paranormal phenomenon comprising the steps of: providing a microphone, providing a means for capturing and storing a digitized representation of an environmental sound as a computer file on a computer readable and rewritable medium, providing a means for playing said digitized representation of an environmental sound from said computer file on said computer readable and rewritable medium, providing a speaker, capturing said environmental sound by means of said means for capturing and storing a digitized representation of an environmental sound as a computer file on a computer readable and rewritable medium, playing said environmental sound by means of said means for playing said digitized representation of an environmental sound from said computer file on said computer readable and rewritable medium, wherein the environmental sound is played at least one second after being captured. In another embodiment sound environmental sound is continuously captured during playing of said environmental sound. In still another embodiment the environmental sound is played at least five seconds after being captured. It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective drawing of two preferred embodiment of the present invention.

FIG. 2 is a general perspective drawing of a preferred embodiment of the present invention.

FIG. 3 is a perspective drawing of a preferred embodiment of the head phones of the present invention.

FIG. 4 is a general perspective view of a preferred embodiment of the invention being used by a user.

FIG. 5 is a general perspective view of a preferred embodiment of the invention being used by a user.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

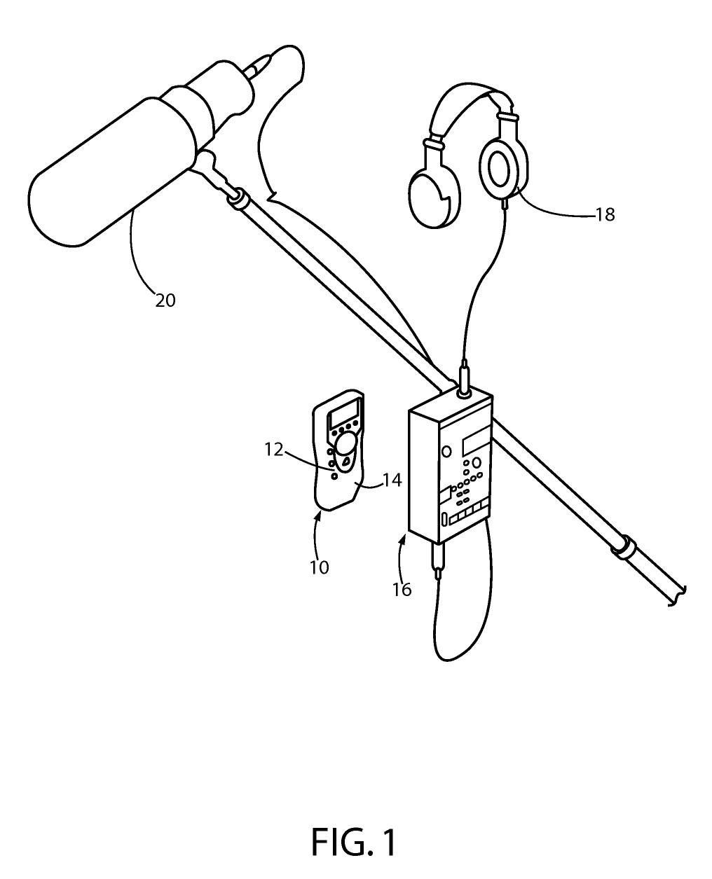

Reference is now made, more particularly, to FIG. 1 which is a general perspective drawing of two preferred embodiment of the present invention. Stand alone digital voice recorder 10 with integrated microphone 12 and speaker 14 is shown along side a similarly functioning component system. The component system comprises digital voice recorder 16, headphones 18, and high sensitivity microphone 20. Both systems function similarly, however the more serious user can benefit from the higher performance of the component system.

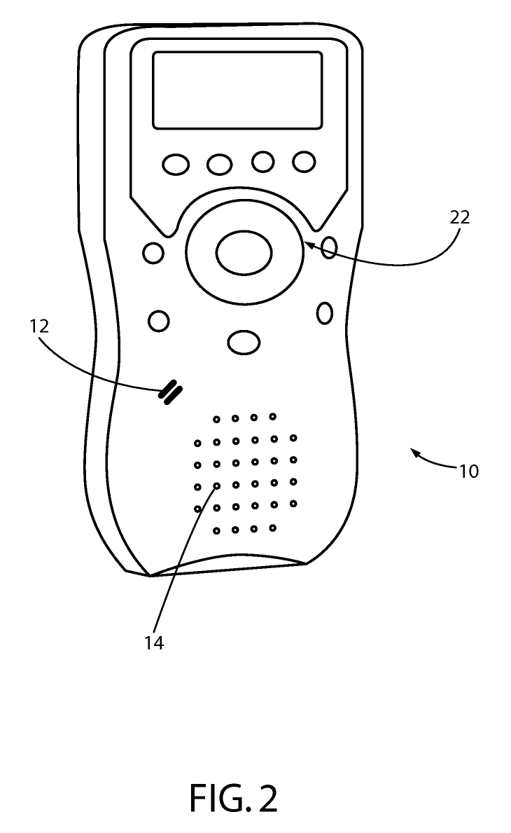

Reference is now made, more particularly, to FIG. 2 which is a general perspective drawing of a stand alone digital voice recorder 10 comprising integrated microphone 12, integrated speaker 14 and user interface 22.

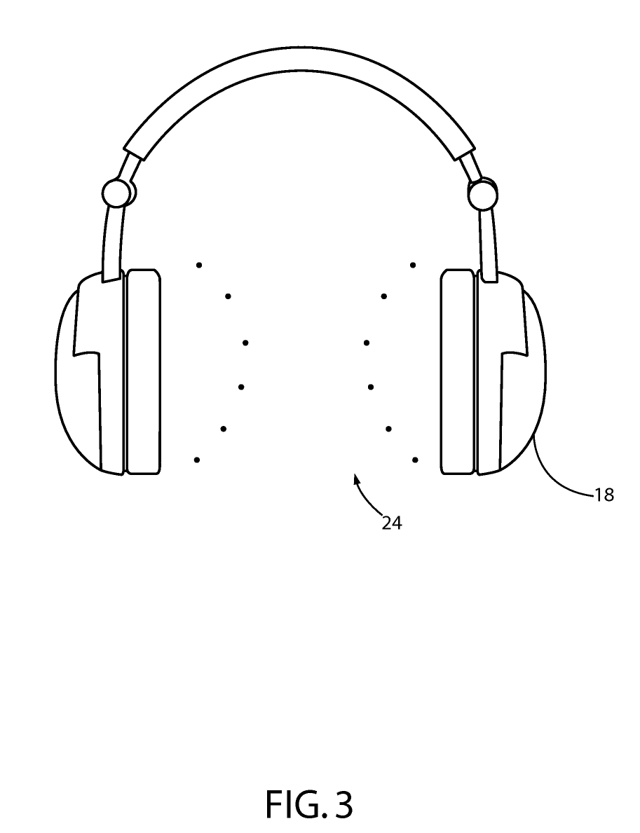

Reference is now made, more particularly, to FIG. 3 which is a perspective drawing of a preferred embodiment of the head phones 18 of the present invention. Headphones 18 can be used to play recorded audio 24.

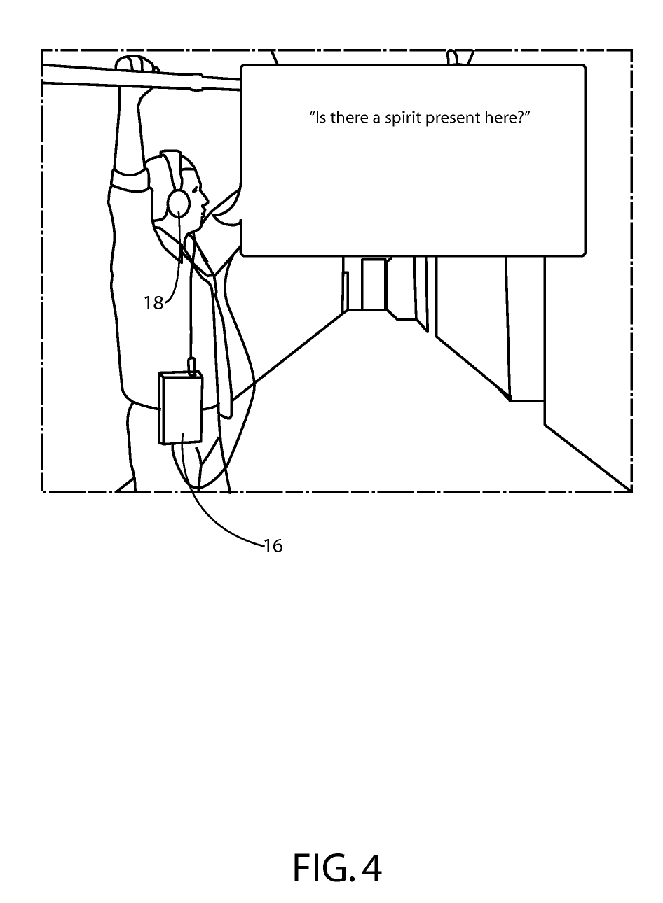

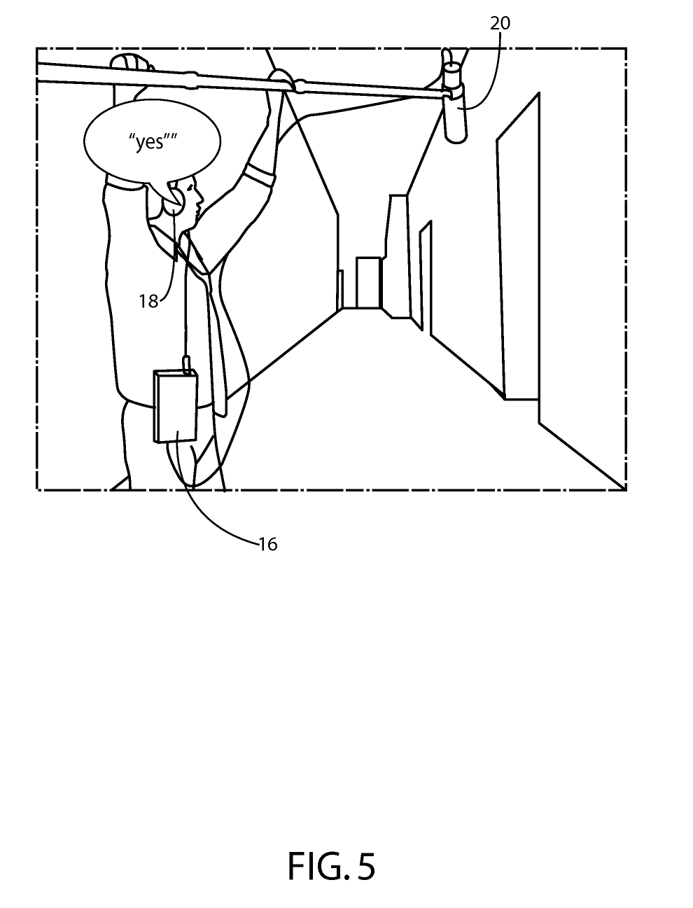

Reference is now made, more particularly, to FIGS. 4-5 which are general perspective views of a preferred embodiment of the invention being used by a user. The user would set a time delay of their choice, put on a headset 18 that is plugged into the digital voice recorder 16 and initiate recording. The user could then ask a question or some other words to initiate a response from an entity. The user would then be able to hear any audio responses from said entity after the preselected time delay had run.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A portable audio recorder for digitally recording environmental sound comprising:
a microphone,
a means for capturing and storing a digitized representation of an environmental sound as a computer file on a computer readable and rewritable medium,
a means for playing said digitized representation of an environmental sound from said computer file on said computer readable and rewritable medium,
a speaker,
wherein said digitized representation of an environmental sound is automatically played at a user selected time interval of at least one second.

2. The portable audio recorder for digitally recording environmental sound of claim 1, wherein the user selected time interval is at least five seconds.

3. The portable audio recorder for digitally recording environmental sound of claim 1, wherein the portable audio recorder records a sound associated with a paranormal phenomenon.

4. The portable audio recorder for digitally recording environmental sound of claim 1, wherein said speaker is at least one speaker positioned in a headset.

5. The portable audio recorder for digitally recording environmental sound of claim 1, wherein said microphone is built into an external body of the portable audio recorder.

6. The portable audio recorder for digitally recording environmental sound of claim 1, wherein said speaker is built into an external body of the portable audio recorder.

7. The portable audio recorder for digitally recording environmental sound of claim 1, wherein said microphone is built into an external body of the portable audio recorder, and wherein said speaker is built into the external body of the portable audio recorder.

8. A method for obtaining an audio recording associated with a paranormal phenomenon comprising the steps of:
providing a microphone,
providing a means for capturing and storing a digitized representation of an environmental sound as a computer file on a computer readable and rewritable medium,
providing a means for playing said digitized representation of an environmental sound from said computer file on said computer readable and rewritable medium,
providing a speaker,
capturing said environmental sound by means of said means for capturing and storing a digitized representation of an environmental sound as a computer file on a computer readable and rewritable medium,
playing said environmental sound by means of said means for playing said digitized representation of an environmental sound from said computer file on said computer readable and rewritable medium,
wherein the environmental sound is played at least one second after being captured.

9. The method for obtaining an audio recording associated with a paranormal phenomenon of claim 8, wherein sound environmental sound is continuously captured during playing of said environmental sound.

10. The method for obtaining an audio recording associated with a paranormal phenomenon of claim 8, the environmental sound is played at least five seconds after being captured.
